(19) United States
(12) Patent Application Publication
(10) Pub. No.: US 2007/0236435 A1
(43) Pub. Date: Oct. 11, 2007

(54) Driver circuit, display apparatus, and method of driving the same

(75) Inventors: Kiyoshi Miyazaki, Kanagawa (JP); Keigo Ootani, Kanagawa (JP); Hidekazu Nagato, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/783,292

(22) Filed: Apr. 6, 2007

(30) Foreign Application Priority Data
Apr. 11, 2006 (JP) 108271/2006

(51) Int. Cl. G09G 3/36

(52) U.S. Cl. 345/87

(57) ABSTRACT

A display apparatus drives a data line on a time division basis. In this process, the data line is driven twice, namely in two modes: a precharge mode and a drive mode. Before the drive mode in which a drive voltage according to display data is supplied to a data line among a set of data lines to be driven on a time division basis, a precharge voltage is supplied at least to a data line adjacent to the data line individually.

### FIELD OF THE INVENTION

The present invention relates to a driver circuit which drives a data line in a display apparatus on a time division basis and a display apparatus with a time division driver circuit and a method of driving the same.

### BACKGROUND OF THE INVENTION

In the field of active-matrix liquid crystal display apparatuses, the precharge technique which speeds up liquid crystal driving has been known. In this precharge technique, prior to driving a data line according to display data, the data line is precharged to a given voltage to reduce the charge/discharge of the data line in supplying a drive voltage according to display data (for example, see Laid Open Japanese Application JP 2005-37832A and JP 2005-115342A).

On the other hand, the electronic field-effect mobility of poly-Si is approx. several dozen to 200 cm²/Vs, which is higher than that of amorphous Si (approx. 0.5 to 1 cm²/Vs). For this reason, the use of poly-Si TFTs on a substrate on which a liquid crystal display is formed makes it possible to create peripheral circuits such as compact practical signal circuits and scanning circuits.

One proposed approach to a high-resolution high-definition liquid crystal display apparatus which uses poly-Si TFTs (thin film transistors) is an RGB time division driving method which uses a time division switch on a substrate bearing a liquid crystal display, and a driver IC. In one example of a liquid crystal display apparatus based on such an RGB time division driving method, one output terminal of the driver IC is connected with three data lines in a liquid crystal display (they are also called drain lines or source lines, hereinafter called data lines, and correspond to R, G and B pixels) through a time division switch provided on a substrate on which the liquid crystal display lies. In the RGB time division driving method, one horizontal period is time-divided into three periods and one type of data line is selected among three types of data lines corresponding to R, G and B sequentially in each period. Then, the driver IC outputs display data corresponding to the data line selected by the time division switch thorough an output terminal. As a consequence, a display signal corresponding to the display data is given to the liquid crystal in the liquid crystal panel, thereby achieving tone reproduction. In the RGB time division driving method, a signal is sent from one output terminal of a driver IC to three data lines as described above and thus the number of output terminals of the driver IC can be one third of the number of data lines (horizontal pixels) in the liquid crystal display and the required number of driver ICs can be smaller than in the conventional line-sequential driving method. Also the number of terminals for connection between the driver IC and the substrate on which the liquid crystal display and the time division switch are formed can be one third of that in the conventional line sequential driving method, making it possible to realize a liquid crystal display apparatus with higher definition and higher resolution.

However, when driven on a time division basis, if a data line R is selected and a display signal with negative polarity is written, charge/discharge to parasitic capacitance between pixel electrodes would occur because an adjacent pixel electrode remains positive, leading to increased power consumption. Besides, the required luminance could not be attained in some cases.

As a solution to this problem, JP 2003-167556A discloses a precharge technique like the abovementioned patent documents. In the display apparatus described in this patent document, prior to starting driving, all time division switches are turned ON to supply a voltage approximate to a display data drive voltage in advance.

However, the inventor has now recognized that in driving data lines on a time division basis, driving one data line gives an influence on an adjacent line through parasitic capacitance. The degree of influence q is proportional to change in the voltage of the charged line ΔV and the relation q=C×ΔV exists where C1 represents pixel capacitance (panel capacitance) and C represents parasitic capacitance between data lines. In all the techniques described in the abovementioned three patent documents, the same precharge voltage is given to all data lines in order to reduce the influence of high speed driving or parasitic capacitance. In this case, when the data lines are precharged simultaneously, they are precharged to the same voltage. Therefore, voltage change due to coupling would be larger in writing data. This would affect the voltage of an adjacent data line, resulting in color unevenness in a displayed image.

In the time-division-driven display apparatus described in JP 2003-167556A, a time division switch is located on the panel. When a time division switch is located in the data driver, the data line wires must be longer. As the data lines are longer, the parasitic capacitance is larger and the influence of parasitic capacitance becomes larger, leading to more serious display color fluctuation. This is because the switch on the panel for a driven pixel is not turned OFF and thus the data line is more susceptible to the influence of charge switching for other data lines.

### SUMMARY

According to one aspect of the present invention, in a driving method for a display apparatus which supplies a drive voltage according to display data to a data line and drives it on a time division basis, before supplying a drive voltage according to the display data to a data line among a set of data lines to be driven on a time division basis, a precharge voltage is supplied at least to a data line adjacent to the data line individually wherein the precharge voltage is adequate for the adjacent data line.

According to another aspect of the invention, a display apparatus includes: a display panel; and a driver which supplies a drive voltage according to display data to a data line located on the display panel and drives it on a time division basis. Here, before supplying a drive voltage according to the display data to a data line among a set of data lines which the driver drives on a time division basis, the driver supplies, at least to a data line adjacent to the data line, a precharge voltage adequate for the adjacent data line individually.

In the invention, by precharging at least a data line adjacent to a data line to be driven to a precharge voltage adequate for the adjacent data line, change in the voltage of the data line to be driven is reduced. This decreases the influence of the adjacent data line on the voltage.

According to the present invention, display color fluctuation in a time-division-driven display apparatus is suppressed.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 shows a display apparatus according to a first embodiment of the present invention;

FIG. 2 is a block diagram showing details of the driver IC of the display apparatus according to the first embodiment;

FIG. 3 shows the substantial unit of the display apparatus according to the first embodiment;

FIG. 4 is a switch timing diagram of the time division switch circuit of the display apparatus according to the first embodiment;

FIG. 5 is an operation timing diagram of a conventional time division driving method; and

FIG. 6 is an operation timing diagram of the time division switch circuit of a display apparatus according to a second embodiment of the present invention.

### DETAILED DESCRIPTION OF THE PREFERRED EMBODIMENTS

Next, preferred embodiments of the present invention will be described in detail referring to the accompanying drawings. These embodiments concern time-division-driven liquid crystal display apparatuses to which the present invention is applied.

### First Embodiment

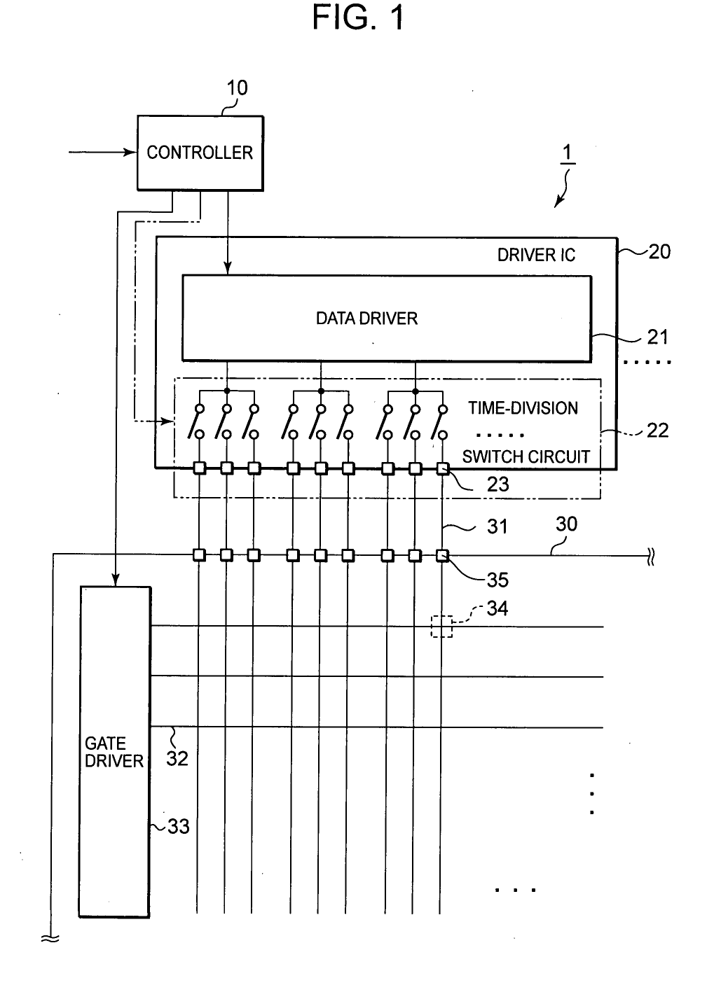

FIG. 1 shows a display apparatus according to the first embodiment of the invention. As illustrated in FIG. 1, a liquid crystal display apparatus 1 based on an RGB time division driving method according to this embodiment includes: an active matrix liquid crystal display panel 30; a gate driver 33 for driving scanning lines; a driver IC 20 including a data driver (source driver) 21 for driving data lines; a controller 10 for supplying display data and various timing signals; and a power supply circuit (not shown). The gate driver may be located outside the display panel or the driver IC including the data driver may be located on the panel.

The liquid crystal display panel 30 includes: a TFT array substrate where plural scanning lines (gate lines) 32 and plural data lines 31 are arranged in a lattice pattern, pixel electrodes 34 are arranged in a matrix pattern, and TFTs (not shown) as switching elements are connected with the source (data) lines 31 and pixel electrodes; a facing substrate (not shown) where facing electrodes are arranged opposite to the pixel electrodes; and liquid crystal held between these substrates. The source or drain of a TFT is connected with a source line 31 or pixel electrode. Its control terminal (gate) is connected with a gate line 32 to turn on and off the TFT.

Output of the driver IC including the data driver 21 is connected through external terminals 23 of the driver IC 20 and external terminals 35 of the liquid crystal display panel 30 to the gate lines 32 and source lines 31. The controller 10 receives input display data from an external host such as a PC and controls the gate driver 33 and the data driver 21 according to the display data. The display apparatus 1 according to this embodiment has a time division switch circuit 22 (time division SW circuit) in the driver IC 20. The controller 10 generates a switch control signal for the time division SW circuit 22 and sends it to the time division SW circuit 22 to turn on and off the switches. Although in this embodiment the controller 10 controls the switches in the time division SW circuit 22, it is also possible to provide a switch control circuit outside the controller 10, for example, inside the driver IC.

For the liquid crystal display apparatus 1 to make a display, display data (video data) and various timing signals such as vertical synchronizing and horizontal synchronizing signals are sent to the controller 10 from an external host such as a PC. The controller 10 sends the gate driver 33 a clock signal and a selection pulse signal for selecting the gate lines 32 sequentially. The controller 10 also sends the data driver 21 various timing signals and display data for indicating tone corresponding to each data line 31. The data driver 21 generates tone voltage by D/A conversion of the acquired display data and sends it as an image signal to a source line 31 selected in the time division SW circuit 22.

A pulsing scanning signal is supplied from the gate driver 33 to each gate line 32 and when the scanning signal supplied to a gate line 32 is ON, all TFTs connected with the gate line 32 are turned ON. The image signal supplied from the data driver 21 through the time division SW circuit 22 to the source line 31 is supplied through the TFTs turned ON to pixel electrodes. After that, as the scanning signal turns OFF and the TFTs turn OFF, the pixel voltage, which is obtained by adding offset voltage through the TFTs to the supplied image signal, is maintained by pixel capacitance such as liquid crystal capacitance or auxiliary capacitance until a scanning signal is supplied to the gate line 32 for the next frame. As scanning signals are supplied to the gate lines 32 sequentially, given image signals are sent to all pixel electrodes and the image signals are rewritten frame by frame, thereby displaying an image.

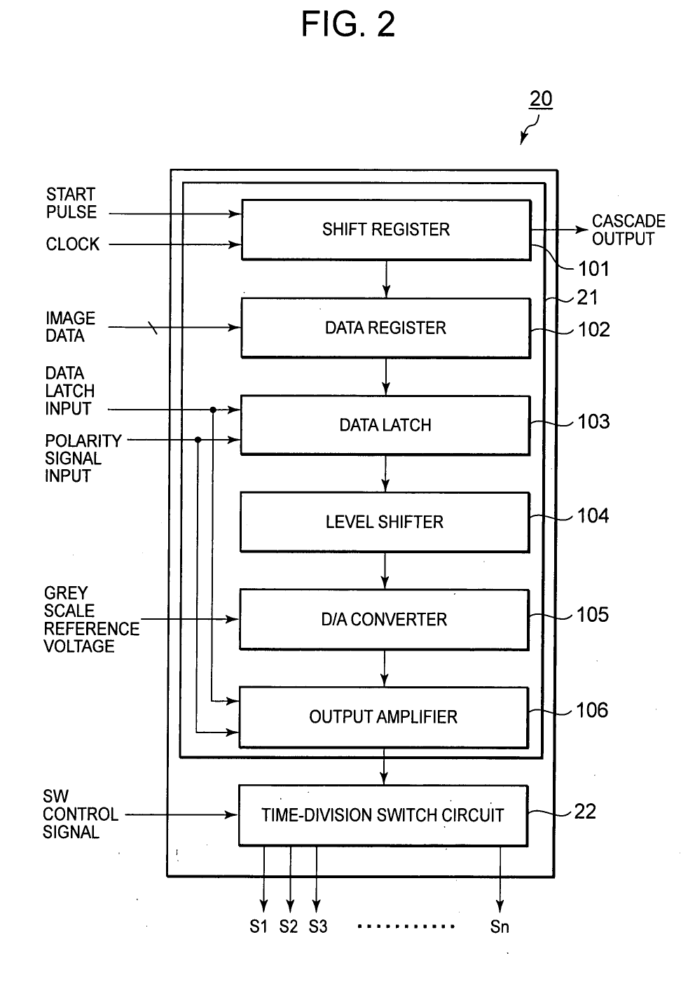

Next, the driver IC 20 will be described. FIG. 2 is a block diagram of the driver IC 20. As illustrated in FIG. 2, the driver IC 20 includes: a data driver 21 consisting of a shift register 101, a data register 102, a data latch 103, a level shifter 104, a D/A converter 105, and an output amplifier 106; and a time division SW circuit 22. Output of the shift register 101 of the driver IC 20 is cascade-connected to a next driver circuit and plural driver ICs 20 are cascade-connected to make up a data drive circuit. The shift register 101 consists of plural registers, the number of which depends on the number of data lines, where it receives a shift start pulse and a clock signal and the start pulse is shifted sequentially according to the clock signal.

The data register 102 consists of as many registers as registers in the shift register 101 where a digital image signal (hereinafter called data) is sent to each register in parallel and each register holds the data sequentially, for example, at the shift pulse falling time.

The data latch 103 receives a data latch signal upon completion of data input to all the registers in the data register 102 and latches all the data latched by the registers in the data register 102. The data latched by the data latch 103 is level-shifted by the level shifter 104 as appropriate.

The D/A converter 105 decodes the level-shifted data and outputs tone voltages. For example, it selectively outputs voltages for 64 tones from a tone reference voltage supplied from the power supply circuit (not shown). The output amplifier 106 amplifies the output of the D/A converter 105 and sends it as an output signal. A data latch signal and a polarity reversal signal which are supplied to the data latch 103 are also supplied to the output amplifier 106, which selects output whose polarity matched to the polarity reversal signal and sends it according to data latch signal timing.

In the display apparatus according to this embodiment, a set of three data lines for R, G and B are connected to one output amplifier. In other words, one output amplifier drives three data lines on a time division basis. The time division SW circuit 22 turns on/off the switches and drives the data lines on a time division basis according to a switch control signal. Although this embodiment assumes that the time division SW circuit 22 is located inside the driver IC 20, obviously it is possible that the time division SW circuit 22 lies on the panel 30.

The time division SW circuit 22 performs time division driving. In the display apparatus 1 according to this embodiment, each driving time as a result of time division is further divided into driving times. In sum, it uses a double drive system which consists of a pre-drive (hereinafter called precharge) mode and a final drive (hereinafter called actual drive).mode.

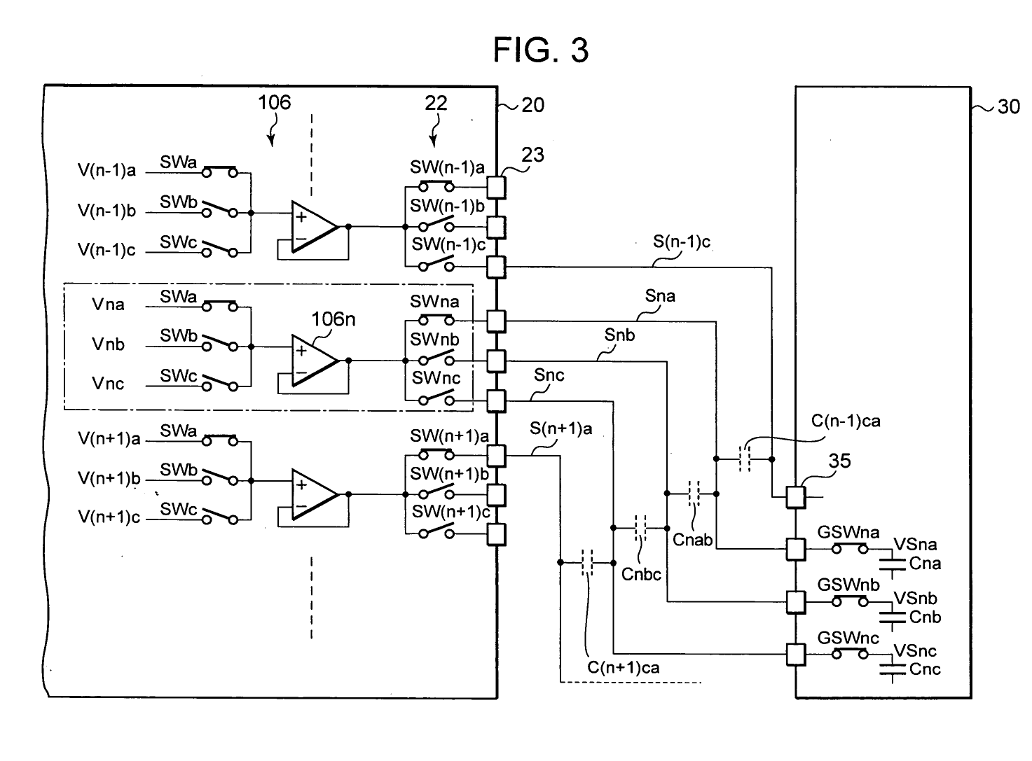

FIG. 3 shows the substantial unit of the display apparatus 1. FIG. 3 illustrates how 3n data lines are driven on a time division basis where three lines for R, G and B constitute one set. It is also possible that more than three data lines, for example, six data lines are driven by a single output amplifier on a time division basis. As for output from the D/A converter 105 of the driver IC 20, a set of three wires are connected to one output amplifier 106n and output of each output amplifier 106n is connected to three data lines Sna, Snb, and Snc through the time division SW circuit 22 having three switches SWna, SWnb, and SWnc. The data lines Sna, Snb, and Snc are connected to pixel capacitances Cna, Cnb, and Cnc through switches GSWna, GSWnb, and GSWnc connected with the gate line 32 on the panel. As for the data lines Sna, Snb, and Snc, coupling capacitance (parasitic capacitance) is generated between neighboring data lines. In this example, coupling capacitance generated between data lines Sn−1c and Sna are expressed by C(n−1)ca, coupling capacitance generated between data lines Sna and Snb are expressed by Cnab, and coupling capacitance generated between data lines Snb and Snc are expressed by Cnbc.

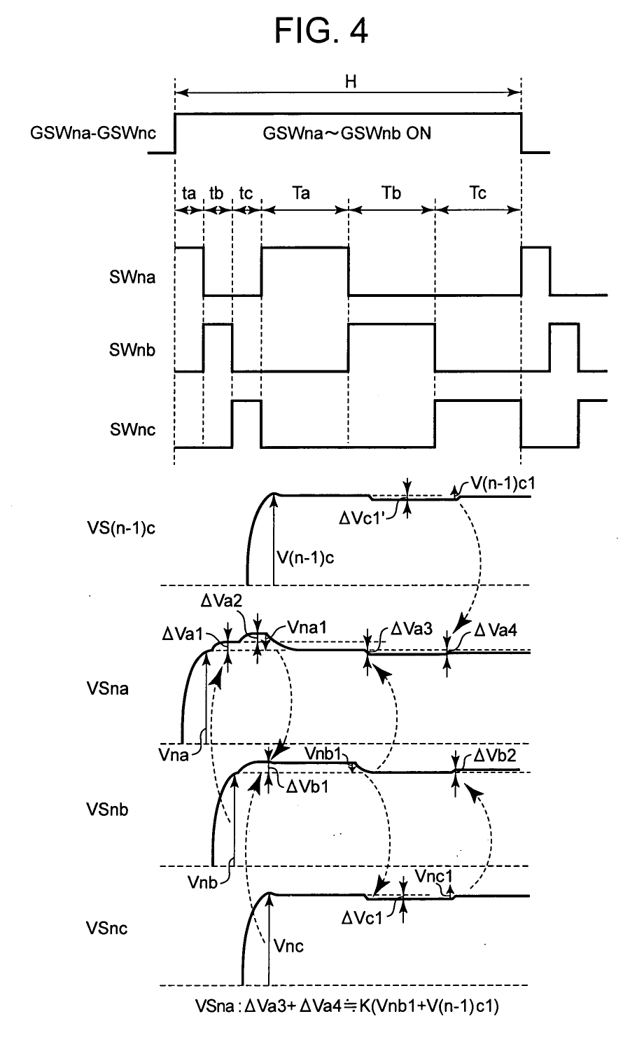

Next, how the display apparatus according to this embodiment operates will be described. FIG. 4 shows drive waveforms for this embodiment. As illustrated in FIG. 4, the waveform for each data line has precharge time periods (ta, tb or tc) and actual drive time periods (Ta, Tb or Tc) for the data line. Here, as an example, the case of driving data lines Sna, Snb, and Snc is explained below. Since the voltage VSna of data line Sna is also affected by adjacent data line S(n−1)c, the voltage of the adjacent data line is also shown.

First, in period ta, data line Sna is precharged to a voltage adequate for data line Sna, in this case, a voltage almost equal to the drive voltage for data line Sna. Next, in period tb, data line Snb is precharged to a voltage almost equal to the drive voltage for data line Snb. Further, in period tc, data line Snc is precharged to a voltage almost equal to the drive voltage for data line Snc. The data lines are thus precharged to their respective drive voltages. After that, data lines Sna, Snb, and Snc are driven on a time division basis. In other words, drive voltages are supplied to data lines Sna, Snb, and Snc in periods Ta, Tb, and Tc, respectively.

In case that switch GSWn on the panel is turned OFF only once in a horizontal period as in this embodiment, there is an influence of coupling capacitance generated between neighboring data lines. Particularly when the display apparatus features a high pixel density with many outputs per driver IC, it must use longer wires and is more susceptible to such influence.

Therefore, in this embodiment, each data line is actually driven after being precharged at a precharge voltage almost equal to the display data voltage for the data line. In other words, since the potential difference between data lines is approximated to the required voltage by precharging the relevant pixel capacitance and coupling capacitance in the precharge mode, influx or efflux of charge through the coupling capacitances in the actual drive mode is suppressed. Therefore, voltage change in the data line is reduced and the influence on the display data is suppressed even if time division driving takes place with GSWn on the panel ON, permitting display of an image without color unevenness.

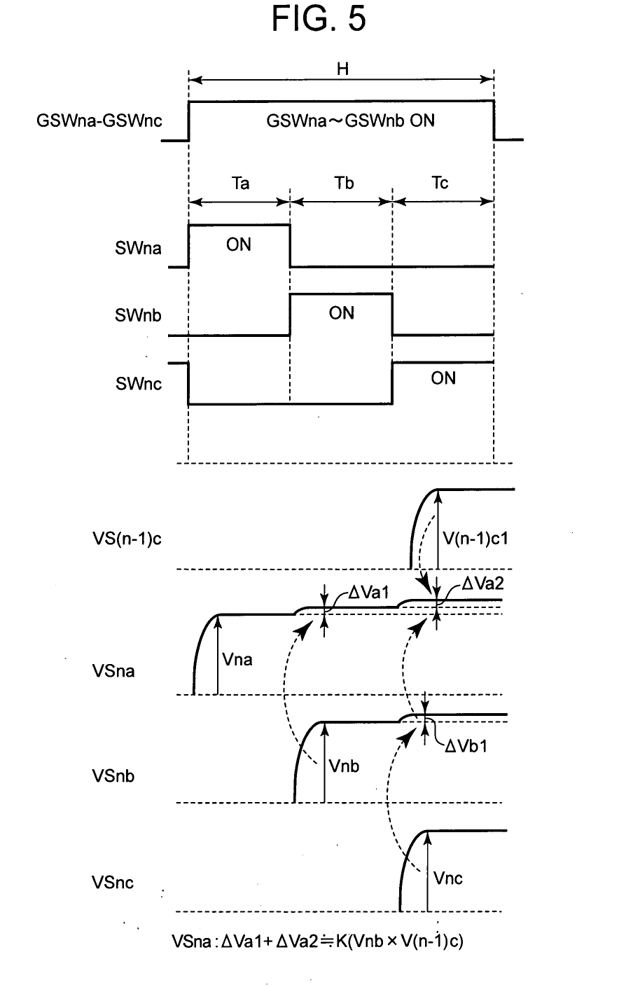

Next, the conventional time division driving sequence will be first explained, and then the effect of the present invention will be described in detail. FIG. 5 shows the conventional time division driving sequence. In the following explanation of voltage change in a data line, for easy understanding, the influence of a data line which is two or more lines away from the line concerned is ignored and only the influence of the most adjacent data lines is considered. For the same reason, consideration is given only to a data line which is most susceptible to coupling capacitance, namely a data line which is first actually driven.

As shown in FIG. 3, supposing that Vna, Vnb, and Vnc represent the drive voltages for data lines Sna, Snb, and Snc respectively, and Cnab and Cnbc represent coupling capacitances between data lines Sna and Snb and between data lines Snb and Snc respectively, and VSna, VSnb, and VSnc represent the voltages of the data lines on the panel, charge ΔQna which flows into data line Sna when Vnb and V(n−1)c change by ΔVnb and ΔV(n−1) respectively can be expressed by the following equation:

$$\begin{matrix}Δ Qna = Δ Qb + Δ Q ( n - 1 ) c \\ = Cnab \times Vnb + C ( n - 1 ) ca \times V ( n - 1 ) c\end{matrix}$$

When the load of data line Sna (except parasitic load) is expressed by Cna, the contribution of charge ΔQna to voltage change can be expressed as follows:

$$\begin{matrix}Δ Vna = Δ Va1 + Δ Va2 \\ \approx Δ Qnb / Cna + Δ Q ( n - 1 ) c / Cna \\ = Cnab / Cna \times Vnb + C ( n - 1 ) ca / Cna \times V ( n - 1 ) c \\ = Kab \times Vnb + {Kac}^{′} \times V ( n - 1 ) c \\ \approx K \times ( Vnb + V ( n - 1 ) c )\end{matrix}$$

Here, coupling capacitance ratios, which are expressed by Kab=Cnab/Cna, Kac′=C(n−1)ca/Cna, are constants of proportion which are uniquely determined by the ratio of pixel capacitance to coupling capacitance. More specifically, Kab is a constant determined by the ratio of data line Sna pixel capacitance Cnac to coupling capacitance Cnab between data line Sna and data line Snb parallel to it while Kac′ is a constant determined by the ratio of data line Sna panel load Cna to parasitic capacitance C(n−1)ac between data line Sna and data line S(n−1)c. ΔQnb and ΔQ(n−1)c represent charges which flow into data lines Snb and S(n−1)c, respectively.

Here, Kxy represents the ratio of parasitic capacitance between data lines x and y to data line x panel load capacitance. As for Kxy, Kyz, Kzx, Kyx and so on, the ratio is almost equal between neighboring lines; therefore for the purpose of illustrating the effect by a simple formula clearly, K is used as an approximate value here and in the explanation given below. Generally, the ratio of parasitic capacitance between lines to panel load capacitance is small and expressed as follows:

K≈Kxy=Cmxy/Cx<<1 (m=n−1,n,n+1,x=ma−m c)

Accordingly, since change in voltage Vna of data line Sna is proportional to the respective voltage changes ΔV(n−1)c and ΔVnb of adjacent data lines S(n−1)c and Snb, and the coupling capacitance ratio K, the only approach to improvement is suppression of voltage changes in the adjacent data lines after level shift in the driver.

An approximation of voltage error due to the influence of coupling capacitance in the above conventional method is explained below. In a horizontal period H, switches GSWna, GSWnb, and GSWnc on the panel are all ON. First, in period Ta, switch SWna turns ON, which supplies drive voltage Vna to data line Sna so that voltage VSna of data line Sna is drive voltage Vna. In the next period Tb, switch SWnb turns ON, which supplies drive voltage Vnb to data line Snb so that voltage VSnb of data line Snb is drive voltage Vnb. At this time, as data line Snb is charged to drive voltage Vnb, voltage VSna of data line Sna increases by ΔVa1 through coupling capacitance Cnab between both the data lines. In the next period Tc, switch SW(n−1)c turns ON, which supplies drive voltage V(n−1)c to data line S(n−1)c so that voltage VS(n−1)c of data line S(n−1)c is drive voltage V(n−1)c. At this time, as data line Snc is charged to drive voltage Vnc, voltage VSnb of data line Snb increases by ΔVb1 through coupling capacitance Cnbc between data lines Snb and Snc. Furthermore, voltage VSna of data line Sna further increases by ΔVa2 through coupling capacitance Cnab between data lines Sna and Snb and coupling capacitance C(n−1)ca between data lines S(n−1)c and Sna.

As described above, an approximation of voltage error due to the influence of coupling capacitance can be expressed by Equation (1) below:

### Change in the voltage of data line Sna, ΔVna:

$$\begin{matrix}Δ Vna = Δ Va1 + Δ Va2 \\ \approx Δ Qnb / Cna + Δ Q ( n - 1 ) c / Cna \\ = Cnab / Cna \times Vnb + C ( n - 1 ) ca / Cna \times V ( n - 1 ) c \\ = Kab \times Vnb + {Kac}^{′} \times V ( n - 1 ) c \\ \approx K \times ( Vnb + V ( n - 1 ) c )\end{matrix} \qquad ( 1 )$$

On the other hand, according to this embodiment, in which data lines are precharged before being actually driven, the sequence is as follows. Again, referring to FIG. 4, in the horizontal period H, switches GSWna, GSWnb, and GSWnc on the panel are all ON. Then, in the precharge mode, first, in period ta, switch SWna turns ON. Simultaneously, switch SWa corresponding to switch SWna also turns ON. The voltage Vna supplied to switch SWa is write voltage (drive voltage), for example, a voltage for an R signal among R, G, and B write signals which are supplied to one pixel. Consequently precharge voltage Vna which is the same as the drive voltage is supplied to data line Sna. Voltage VSna of data line Sna is charged to precharge voltage (=drive voltage) Vna. In this period, the switches other than SWna and SWa, namely SWnb, SWb, SWnc, and SWc are all OFF.

In the next period tb, switch SWnb turns ON. Simultaneously, switch SWb corresponding to switch SWnb also turns ON. The voltage Vnb supplied to switch SWb is, for example, a voltage for the G signal among the R, G, and B write signals which are supplied to the pixel as mentioned above. Consequently precharge voltage Vnb which is the same as the drive voltage is supplied to data line Snb and voltage VSnb of data line Snb is charged to precharge voltage (=drive voltage) Vnb. At this time, as data line Snb is charged to precharge voltage Vnb, voltage VSna of data line Sna increases by ΔVa1 through coupling capacitance Cnab between both the data lines. In this period, SWna, SWa, SWnc, and SWc are OFF.

In the next period tc, switch SW(n−1) turns ON. Simultaneously, switch SWc corresponding to switch SWnc also turns ON. The voltage Vnc supplied to switch SWc is, for example, a voltage for the B write signal among the R, G, and B write signals which are supplied to the pixel. Consequently precharge voltage V(n−1)c which is the same as the drive voltage is supplied to data line S(n−1)c, so that voltage VS(n−1)c of data line S(n−1)c is precharge voltage (=drive voltage) V(n−1)c. At this time, as data line S(n−1)c is charged to precharge voltage V(n−1)c, voltage VSna of data line Sna further increases by ΔVa2 through coupling capacitance C(n−1)ca between data lines Sna and S(n−1)c. In this period, SWna, SWa, SWnb, and SWb are OFF. Next, in the actual drive mode, first, in period Ta, switches SWna and SWa turn ON and the voltage for the R signal supplied to the above pixel, namely the same voltage Vna as supplied in period ta, is supplied to data line Sna, so that voltage VSna of data line Sna is drive voltage Vna. In other words, VSna changes from VSna=Vna+ΔVa1+ΔVa2 to VSna=Vna and the amount of this change is expressed by Vna1=−(ΔVa1+AVa2)=Kx{−(Vnb+V(n−1)c)}; When the voltage of data line Sna changes by Vna1 in this way, the voltages of data lines Snb and Snc also change by (drive voltage)×K². In this period, SWnb, SWb, SWnc, and SWc are OFF.

In the next period Tb, switches SWnb and SWb turn ON. Consequently the voltage for the G signal supplied to the above pixel, namely the same voltage Vnb as supplied in period tb, is supplied to data line Snb, so that voltage VSnb of data line Snb is drive voltage Vnb. Consequently voltage VSnb decreases approximately ΔVb1. This change is referred to as Vnb1. Due to change Vnb1, the voltage of data line Sna further decreases by ΔVa3 through coupling capacitance Cnab between data lines Sna and Snb. Also, due to changes in voltages VSna and VSnb of data lines Sna and Snb, voltage VSnc of data line Snc changes by ΔVc1 from Vnc. In this period, SWna, SWa, SWnc, and SWc are OFF.

In the last period Tc, switches SWnc and SWc turn ON. Consequently the voltage for the B signal supplied to the above pixel, namely the same voltage as supplied in period tc, is supplied to data line Snc, so that voltage VSnc of data line Snc is drive voltage Vnc. Consequently the voltage increases by ΔVc1. Due to this voltage change Vnc1, voltage VSnb of data line Snb increases by ΔVb2 through coupling capacitance Cnbc between data lines Snb and Snc. Also, voltage VSna of data line Sna increases by ΔVa4 through coupling capacitance Cnab between data lines Sna and Snb and coupling capacitance C(n−1)ca between data lines S(n−1)c and Sna. In this period, SWna, SWa, SWnb, and SWb are OFF.

As far as an approximation of voltage error due to the influence of parasitic capacitance is concerned, only voltage change in the drive mode, namely voltage change after period Ta, should be considered unlike the conventional sequence as shown in FIG. 5. An approximation of voltage error due to the influence of coupling capacitance can be expressed by Equation (2) below.

### Change in the voltage of data line Sna:

$$\begin{matrix}Δ Vna = Δ Va3 + Δ Va4 \\ = ( Kab \times Vnb1 ) + \{ {Kac}^{′} \times V ( n - 1 ) c1 + Kab \times Δ Vb2 \} \\ = ( Kab \times Vnb1 ) + \{ {Kac}^{′} \times V ( n - 1 ) c1 + Kab \times \\ Kbc \times Δ Vnc1 \} \\ \approx ( Kab \times Vnb1 ) + \{ {Kac}^{′} \times V ( n - 1 ) c1 \} \\ \approx K ( Vnb1 + V ( n - 1 ) c1 )\end{matrix} \qquad ( 2 )$$

Here, although “Kab×ΔVb2” and “Kab×Kbc×ΔVnc1” represent the influences from data line Snc (line after the next to data line Sna) through data line Snb, these are less influential (squared constants of proportion) and ignored in this comparison.

Among data lines Sna, Snb, and Snc, taking a look at Sna which is driven first and the largest in voltage change through parasitic capacitance with adjacent lines, the ratio of change in this embodiment to change in the conventional method shown in FIG. 5 is expressed based on Equations (1) and (2) as follows:

(Vnb1+V(n−1)c1)/(Vnb+V(n−1)c) (3)

where Vnb1 represents drive voltage (change) to negate voltage change ΔVb1 due to adjacent data line Snc in order to return the drive voltage to Vnb and holds the following relation:

Vnb1=ΔVb1=Kbc×Vnc=K×Vnc

where Vnb1<<Vnc

From a similar observation and as illustrated in FIG. 4, it is apparent that the relation V(n−1)c1<<Vnb1 exists. Hence, it can be understood that the relation “Equation (3)<<1” holds and the change is K (<<1) times smaller than in the conventional method. The above observations have been made on the premise of halftone reproduction which requires a normal display quality (Vna to Vnc are several volts) but not a special case that Vna to Vnb are 0 V (black) or equal.

In this way, the supply of a drive voltage changes the voltage of a data line, which influences the voltage of an adjacent data line. This influence is proportional to change in the voltage of the former data line. In this embodiment, all the data lines are precharged to their respective drive voltages: in other words, they are driven twice. For this reason, while in the conventional method the influence of coupling capacitance is K×amount of adjacent line voltage change, in this embodiment it is K×K×amount of adjacent line voltage change and thus much smaller.

### Second Embodiment

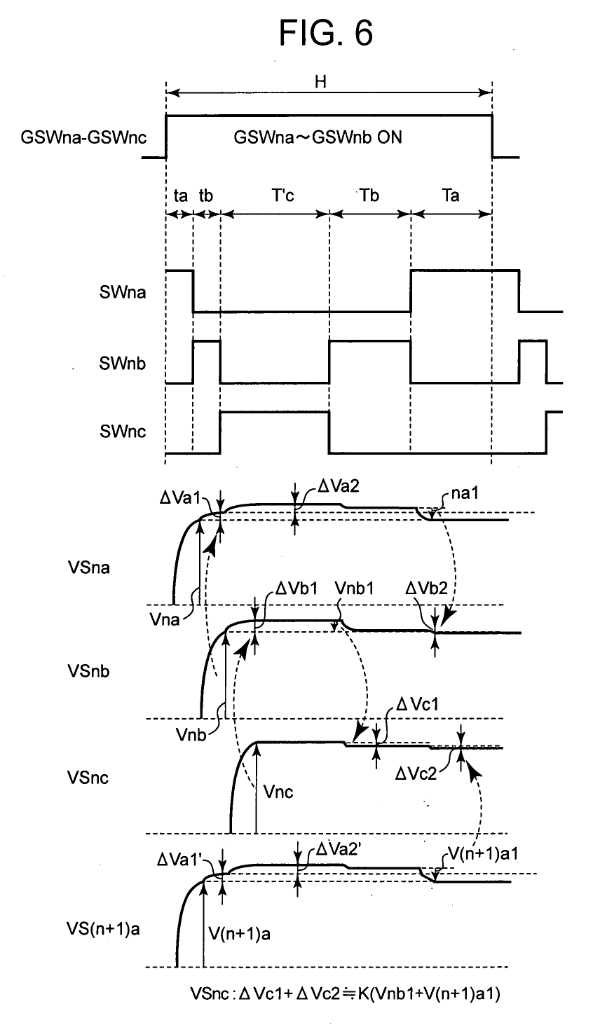

Next, a second embodiment of the present invention will be described. FIG. 6 is a drive timing diagram according to this embodiment. In the first embodiment, all the data lines are precharged before being actually driven. However, a similar effect may be achieved by precharging and driving some of the data lines simultaneously.

In the case as shown in FIG. 6, data line Snc is precharged and driven simultaneously. This saves a single switch action, permitting higher driving efficiency.

As illustrated in FIG. 6, in a horizontal period H, switches GSWna, GSWnb, and GSWnc on the panel are all ON. Then, in period ta, switch SWna turns ON. Consequently precharge voltage Vna which is the same as the drive voltage is supplied to data line Sna and voltage VSna of data line Sna is precharge voltage (=drive voltage) Vna. In the next period tb, switch SWnb turns ON. Consequently precharge voltage Vnb which is the same as the drive voltage is supplied to data line Snb and voltage VSnb of data line Snb is precharge voltage (=drive voltage) Vnb. At this time, as data line Snb is charged to precharge voltage Vnb, the voltage of data line Sna increases by ΔVa1 through coupling capacitance Cnab between both the data lines.

In the next period Tc′, switch SWnc turns ON. Consequently, drive voltage Vnc is supplied to data line Snc and voltage VSnc of data line Snc is drive voltage Vnc. In this example, for data line Snc, the precharge period is also the drive period. Therefore, period Tc′ should be somewhat longer than the other drive periods Ta and Tb; for example, it may be equal to ta+Ta in the first embodiment. At this time, as data line Snc is charged to drive voltage Vnc, voltage VSnb of data line Snb increases by ΔVb1 through coupling capacitance Cnbc between data lines Snb and Snc. Also, the voltage of data line Sna further increases by ΔVa2 through coupling capacitance Cnab between data lines Sna and Snb.

In the next period Tb, switch SWnb turns ON. Consequently, drive voltage Vnb is supplied to data line Snb, so that the voltage of data line Snb is drive voltage Vnb. In other words, Vsnb changes from VSnb=Vnb+AVb1 to VSnb=Vnb. The amount of this voltage change is expressed by Vnb1. When voltage VSnb of data line Snb changes by Vnb1 in this way, voltage VSnc of data line Snc decreases by ΔVc1. Voltage VSnc of data line Sna also decreases by drive voltage xK².

In the next period Ta, switch SWna turns ON. Consequently, drive voltage V(n+1)a is supplied to data line S(n+1)a, so that voltage VS (n+1)a of data line S(n+1)a returns to drive voltage V(n+1)a. Under the influence of this change V(n+1)a1, voltage VSnc of data line Snc decreases by ΔVc2 through coupling capacitance C(n+1)ca.

An approximation of voltage error due to the influence of coupling capacitance can be expressed by Equation (4) below. In this example, consideration is given only to data line VSnc which is first driven and most susceptible to coupling capacitance.

### Change in the voltage of data line Snc:

$$Δ Vc1 + Δ Vc2 = Kbc \times Vnb1 + Kbc \times ( Kab \times Vna1 ) + Kca \times V ( n + 1 ) a1 \qquad ( 4 )$$

where the following relations hold: Vna>>Vna1, Vnb>>Vnb1, V(n+1)a>>V(n+1)a1. Like the case as represented by Equation (2), as for voltage changes in data line's, the change even in a data line which is driven first in a horizontal period, which is most susceptible to coupling capacitance, is much smaller than in the conventional method.

In this embodiment as well, drive voltage change in time division driving can be minimized and the problem of display color fluctuation can be prevented. In the first embodiment, a set of data lines (Sna, Snb, and Snc) to be driven on a time division basis are all precharged; however, a similar effect can be achieved even when at least a data line adjacent to a data line to be actually driven is precharged as in the second embodiment.

The invention is not limited to the above embodiments and it is obvious that the invention may be embodied in other various ways without departing from the spirit and scope thereof. In the description of this embodiment, it has been assumed that the time division SW circuit is incorporated in the driver IC 20 together with the data driver; however, the time division SW circuit may be located on the panel. When the time division SW circuit is located in the driver IC 20, the line from the driver IC 20 to the panel 30 must be longer and the influence of coupling capacitance might be larger. Even if that is the case, the double drive method according to the present invention will be very effective in reducing drive voltage changes in time division driving. Although this embodiment concerns a frame reversal drive system, the invention may be applied to other various drive systems such as dot reversal drive systems and column reversal drive systems.

What is claimed is:

1. A driving method for a display apparatus which supplies a drive voltage according to display data to a data line and drives said display apparatus on a time division basis, comprising:
before supplying a drive voltage according to the display data to a data line among a set of data lines to be driven on a time division basis,
supplying, at least to a data line adjacent to the data line, a precharge voltage adequate for the adjacent data line individually.

2. The driving method as claimed in claim 1,
wherein said precharge voltage is supplied to each data line individually.

3. The driving method as claimed in claim 2, wherein the precharge voltage is almost equal to a drive voltage for the data line according to display data.

4. The driving method as claimed in claim 3, wherein said set of data lines are related to a red color line, green color line and blue color line for one image pixel.

5. A driver, comprising:
a driving circuit which supplies a drive voltage according to display data to a data line; and
a. controlling circuit which controls said driving circuit so that before supplying a drive voltage according to display data to a data line among a set of data lines to be driven on a time division basis, the driving unit supplies, at least to a data line adjacent to the data line, a precharge voltage adequate for the adjacent data line individually.

6. The driver as claimed in claim 5, wherein said precharge voltage is supplied to each data line individually.

7. The driver as claimed in claim 6, wherein the precharge voltage is almost equal to a drive voltage for the data line according to display data.

8. The driver as claimed in claim 7,
wherein the driving circuit includes an output amplifier for supplying a drive voltage according to the display data, and a time division selector unit connected between the output amplifier and data lines and driven by said controlling circuit.

9. A display apparatus comprising:
a driver according to said claim 1; and
a display panel which is driven by said driver.

10. A driving method for a display apparatus precharging each data line individually in a precharge period; and
in a data drive period following to said precharge period, driving said each data lines based on an image data to each data line on a time division basis.

11. The driving method as claimed in claim 10, wherein said each data line are precharged on a time division basis.

12. The driving method as claimed in claim 11, wherein said each data line corresponds to a set of a first data line, a second data line and a third data line for one pixel, said first to third data lines relates to red, green and blue color.

13. The driving method as claimed in claim 12,
wherein in said precharge period, said first to third data line are precharged in that order, and in said data drive period, said first to third data line are driven in that order.

14. The driving method as claimed in claim 12,
wherein in said precharge period, said first to third data line are precharged in that order, and in said data drive period, said third data line is driven before said first and second data lines are driven.

15. The driving method as claimed in claim 14,
wherein said third line is precharged and driven continuously.

16. The driving method as claimed in claim 15,
wherein said data lines are prechared and driven by a time division selector which is located in a display driver.

17. The driving method as claimed in claim 15,
wherein said data lines are precharged and driven by a time division selector which is located in display panel having a plurality of pixels.

18. The driving method as claimed in claim 11,
wherein said precharge period is shorter than said data drive period.

19. The driving method as claimed in claim 12,
wherein said set of first to third data lines are coupled to a single amplifier, precharge signals and image data on said first to third lines are transferred via a first switch group, said amplifier and a second switch group to a display panel.

20. The driving method as claimed in claim 19,
wherein first switches of said first and third switch group are turned ON and second switches of said first and second switch groups and third switches of said first and second groups third are turned OFF, when first data lines are precharged and driven.
